(19) United States
(12) Patent Application Publication
(10) Pub. No.: US 2012/0137243 A1
(43) Pub. Date: May 31, 2012

(54) RATIONALE DEVELOPMENT AND EVALUATION TOOL

(75) Inventors: Gareth Armstrong, Nottingham (GB); Robert H. Bracewell, Cambridge (GB); Marina Gourtovaia, Ely (GB)

(73) Assignee: ROLLS-ROYCE PLC, LONDON (GB)

(21) Appl. No.: 13/378,852

(22) PCT Filed: Jun. 16, 2010
(86) PCT No.: PCT/EP10/03609

§ 371 Date: Jan. 27, 2012

(30) Foreign Application Priority Data
Jun. 26, 2009 (GB) 0911031.3
Dec. 8, 2009 (GB) 0921457.8

(51) Int. Cl. G06F 3/048

(52) U.S. Cl. 715/772

(57) ABSTRACT

A tool and method for capturing information gathered during an analysis project is provided. The tool comprises a storage means for storing the analysis information generated or acquired during progress of an analysis project, wherein the analysis information is in the form of a plurality of graphical representations. Each graphical representation denotes a plurality of entities under analysis and the plurality of graphical representations comprises at least one representation of a first kind and at least one representation of a second kind. Input means is provided to allow a user to generate each graphical representation using a first or second predetermined structure according to its kind, said graphical representations being arranged for storage as a plurality of graphical representation files in the storage means.

The present invention relates to a method, tool and system for improving the efficiency of a reasoned process and more particularly, although not exclusively, to improvements in the efficiency of the capture of the rationale behind engineering design decisions.

Designing complex systems or products often involves many specialists working together as a large interdisciplinary team. Each design decision can be influenced by many complex, and often competing, factors and alternative resolutions of such factors should be considered to achieve an optimal solution. Even in the case that an interdisciplinary team is not required, multiple solutions to a single problem or goal may need to be evaluated. Furthermore, engineering problems rarely exist in isolation and the secondary consequences of a particular problem or solution often require consideration prior to finalising a design choice.

For example, during development of a gas turbine engine, machining or material choices for one component can impact on the freedom of design available for adjacent and even remote components. Even within a single component, such as for example an impeller, increasing strength in one region of the component may place additional strain on another region such that the design or optimisation of a single component alone can result in a complicated interwoven set of problems to be resolved.

Whilst the above example of an impeller relates purely to the physical form of a component, it will be understood that a similar problem-solving mindset is required, not only when considering physical or mechanical attributes of a product, but also for methods and processes in which one action can impact on another.

Solving such problems usually involves a highly skilled team of experts looking at various possible issues and potential solutions. During this process many design issues are studied in depth, only some of which actually contribute to the final design solution. However all the issues studied have in some way contributed to a design rationale, and therefore could be important in solving future design problems in the same or different technical fields. In traditional design reports and other methods of capturing design rationale, the issues studied that did not affect the final design solution, are not usually fully documented. Similarly, rejected solutions to problems have also been discarded or not stored with a view to using the results again.

Tools and methods for capturing the design rationale and making such data readily available for future reference are becoming increasingly important in high technology industries as: design complexity grows, team sizes grow, and experts are redeployed on new projects or change employment. Designers and engineers working on a particular design may not even be located in the same country, let alone building, and the storage and accessibility of data and redeployment of experts, with the risk that they take their knowledge of design rationale with them, presents a real problem to companies wishing to manage an effective knowledge base.

However another problem exists in that capturing of design rationale can produce a significant amount of information that is often lacking in structure. Thus efforts expended in capturing such data can prove to be wasted if the captured data cannot be navigated with ease. Furthermore a logical layout and format of data capture for one engineering team or discipline may be considered illogical to another. Thus the capturing of design rationale in an informal, unstructured manner has been found to provide relatively little ongoing benefit. Design problems themselves are usually ill-defined and rely heavily on domain knowledge, which further highlights the subjective nature of the processes to be captured.

More complex problems induce cognitive processes with a different qualitative character than those of less complex problems. Thus, in more complex problems, the methods of monitoring or controlling the problem solving process itself can impact greatly on the results achieved. This supports the requirement for a process-based approach to design, but also emphasises the need for flexibility in its application to adapt to the complexity of the problem. Furthermore, it underlines the importance of easy retrieval of knowledge (information) relevant to the problem/product.

As a result of these and other reasons, there is a well-established need to avoid repetition of past problems and errors by capturing design rationale in a manner which allows it to be readily re-used or reassessed across varying teams or disciplines.

However a number of previous attempts to capture design rationale have been found to place an undue burden on designers such that the capturing of the design rationale actually inhibits the design process itself. Thus, when time deadlines are imposed for the design process, the additional effort in formulating the required records can result in time away from working on the design solution in question.

In view of the above problems, International Patent Application PCT/GB2004/002690 (International Publication Number WO 2005/001721) proposes an improved tool, which strikes a balance between the flexibility required to accommodate a design process and the structure required to capture the design rationale in a manner which is readily accessible for future interrogation. Aside from merely capturing data, the tool provides a framework for improving the efficiency of a design project itself. An important aspect of that tool is the ability to create “tunnelling” links between issues which occur in a project.

The present invention represents a significant development over the tool and method disclosed in WO 2005/001721.

It is an aim of the present invention to provide a tool, system and method for improving the efficiency of a reasoned process, whilst capturing the generated information, causal dependencies and/or rationale in a manner which facilitates subsequent interrogation and use.

Another aim of the present invention is to provide a method, tool and system to assist a design team in reaching a design for a product or process using decisions associated with one or more other design projects.

According to one aspect of the present invention there is provided an analysis information capture tool comprising: a data store for storing the analysis information generated or acquired during progress of an analysis project, wherein the analysis information comprises a plurality of graphical representations, each graphical representation denoting a plurality of entities under analysis; said plurality of graphical representations comprising at least one representation of a first kind and at least one representation of a second kind; input means for allowing a user to generate each graphical representation using a first or second predetermined structure according to its kind, said graphical representations being arranged for storage as a plurality of graphical representation files in the storage means; and a presentation means for presenting the analysis information comprising the at least one graphical representation, wherein a bi-directional link is created between different graphical representations denoting a common entity under analysis such that the bi-directional link allows navigation between the linked graphical representations by traversing the bi-directional link in either direction.

The first structure for the first kind of graphical representation may comprise a plurality of elements, each element being representative of an entity which impacts on said analysis, and a plurality of connectors, the connectors being representative of a functional or behavioural relationship existing between two or more entities.

According to one embodiment, each connector comprises an accompanying label or descriptor to describe the relationship between two or more elements. The descriptors may comprise an alphanumeric string and may be modelled as an intermediate or relationship node between two or more elements. The graphical representation may take the form of a network of interconnected elements, such as, for example, a functional analysis diagram (FAD).

The second structure for the second kind of graphical representation may comprise an image showing the relative ordering or orientation of a plurality of entities under analysis. The second structure may be considered to represent a map of a plurality of entities under consideration. The second kind of representation may comprise elements for annotation of the entities therein. Connectors may be used to indicate the entities to which the elements relate. The second kind of graphical representation may be indicative of the physical layout of the plurality of entities.

In one embodiment, an additional or alternative kind of graphical representation may comprise an array of elements, each element representing a description of an issue to be analysed, wherein dependency between said issues is denoted by connectors joining said elements. Additionally or alternatively, each element may represent a solution, potential solution or a potential issue. Status indicators may accompany each element to denote the status of resolve for that issue. Such graphical representation may take the form as described in WO2005/001721.

In any embodiment, the elements may be modelled as nodes. Connectors and/or accompanying descriptors may be modelled as intermediate or relationship nodes.

Each graphical representation may be stored as a separate file.

In one embodiment, bi-directional links are provided between graphical representations of the same kind which denote a common entity. Additionally or alternatively, bi-directional links are provided between graphical representations of different kinds which denote a common entity.

Two or more types of bi-directional links may be defined and/or accommodated within the tool. Different types of bi-directional link may be used to distinguish different types of relationship between linked graphical representations. In one embodiment three types of bi-directional links are defined and/or accommodated. The different types of bi-directional link may comprise any or any combination of tunnelling links, transclusion links and/or decomposition links.

Visual indicia, such as geometric features and/or colours or shading may be used to denote a relationship between linked elements in a plurality of graphical representations. Such indicia may concern a linked attribute of the element. Such geometric features may be appended to an element within a graphical representation. The magnitude and/or shape of the geometric feature may denote varying relationships. The indicia may be used to denote the level of the element in the hierarchy, which level may comprise the highest level in the hierarchy at which that element is present. Each level in the hierarchy may be assigned an indicia, such as a colour. Transclusions of an element may appear at different levels of decomposition within the hierarchical model and each transclusion may retain the indicia assigned its originating element.

According to one embodiment, a first kind of graphical representation sharing a common element with a first or second kind of graphical representation may be considered to be a transclusion thereof and may be linked using a transclusion link. Transclusion may enable the creation of a set of parallel linked FADs separately depicting different aspects of a product's function and behaviour, while providing for easy navigation between them. Transcluded elements may offer advantages over copies of elements as they allow for low redundancy and also the ability to reflect editorial operations on the transcluded contents in the transclusions.

Navigation between FADs and labelled geometric assembly views of the same product or process may be made available to improve understanding of the relation between function and layout.

In one embodiment, a first graphical representation may comprise a first element which is made up of a plurality of sub-elements defined in a second graphical representation.

The relationship between said first and second graphical representations may be modelled using a decomposition link. Multiple decompositions of a single element may be provided to allow multiple definitions of an element's functional or physical attributes. The present invention may allow for multiple levels of decomposition.

In one embodiment, decomposition of an element into a plurality of sub-elements is accommodated and a hierarchical structure comprising different levels of decomposition may be defined. According to one embodiment, a hierarchical decomposition structure is exploited to allow improved management of model complexity, while still allowing cross-hierarchical links using standard tunnelling or transclusion.

Visual indicia may be used to represent a useful, harmful, or neutral status of interactions between entities represented by elements in a graphical representation. Visual indicia may comprise colouring of the connector joining said elements.

The present invention may offer advantages in the generation and recordal of complex analysis projects including problem solving and design work by allowing capture of corresponding information in different domains. For example a user may be able to switch between a graph showing functional relationships or issues for a component and a corresponding physical layout for that component. Such differing graph formats offer different perspective on a problem to be resolved and thus help to ensure a comprehensive approach to problem solving is undertaken. Furthermore, certain formats of graph will be more familiar to certain groups of people than others and so the catering for different formats of graph allows the analysis rationale to be captured in a format which is more widely acceptable and understandable to others.

Fine grained linking may also be possible between the FAD models and structured rationale according to Issue-Based Information Structure (IBIS), allowing issues of functionality and behaviour to be efficiently diagnosed and resolved.

According to a second aspect of the present invention there is provided an analysis information capture tool comprising: a storage means for storing the analysis information generated or acquired during progress of an analysis project, wherein the analysis information comprises a plurality of graphical representations arranged for storage as a plurality of graphical representation files; an input means for allowing a user to generate each graphical representation according to a predetermined framework for storage in the storage means, the framework comprising a plurality of elements, each element being representative of an entity which impacts on said analysis, and a plurality of connectors there-between, the connectors being representative of a functional relationship existing between two or more entities; and a presentation means for presenting the analysis information comprising the at least one graphical representation, wherein a bi-directional link is created between instances of the same element appearing in a plurality of graphical representations such that the bi-directional link allows navigation between the associated graphical representation files containing said element by traversing the bi-directional link in either direction.

According to a third aspect of the present invention there is provided a method of capturing analysis information in accordance with the first aspect.

According to a fourth aspect there is provided a method of capturing analysis information in accordance with the second aspect.

According to a fifth aspect of the present invention, there is provided a data carrier comprising machine readable instructions for control of one or more processors to operate in accordance with the first aspect.

According to a sixth aspect of the present invention, there is provided a data carrier comprising machine readable instructions for control of one or more processors to operate in accordance with the second aspect.

According to a further definition of the present invention there is provided an analysis information tool or method using which analysis information generated or acquired during progress of an analysis project is captured in the form of a plurality of graphical representations arranged for storage in a storage means; and using which, a bi-directional link is created between different graphical representations denoting a common entity under analysis, wherein two or more kinds of bi-directional links are defined or accommodated, a first kind of link being used to link the graphical representations when an entity in a first graphical representation is decomposed in a second graphical representation, and a second kind of link being used when an entity in a first graphical representation is transcluded in a second graphical representation, said bi-directional links allows navigation between the linked graphical representations by traversing the bi-directional link in either direction.

Whilst the present invention finds particular application as a tool and methodology for assisting and capturing engineering design processes, the potential uses of the tool include any process or project in which the analysis of a number of related or interrelated entities—such as components, features, functions or events—is required.

Any preferable features described above in relation to the first aspect of the invention may be considered preferable features of the second or subsequent aspects.

The terms ‘framework’ and ‘structure’ are used interchangeably within this specification with reference to the graphical representations.

One or more working embodiments of the present invention are described in further detail below by way of example with reference to the accompanying drawings, of which:

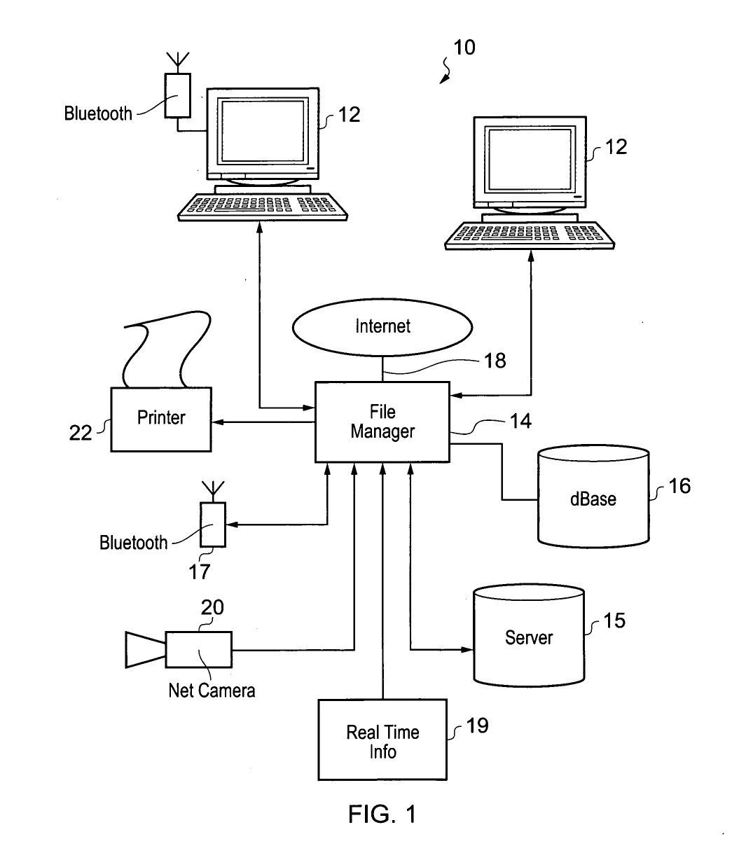

FIG. 1 shows an embodiment of a system for implementation of the present invention;

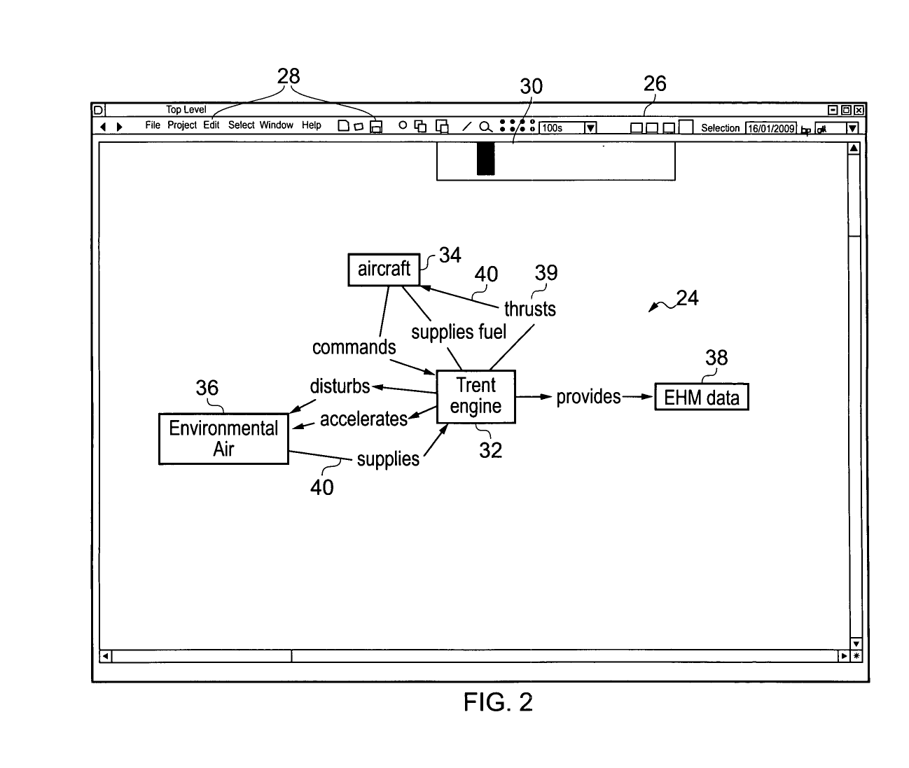

FIG. 2 shows an embodiment of a top level context graphical representation produced according to the present invention;

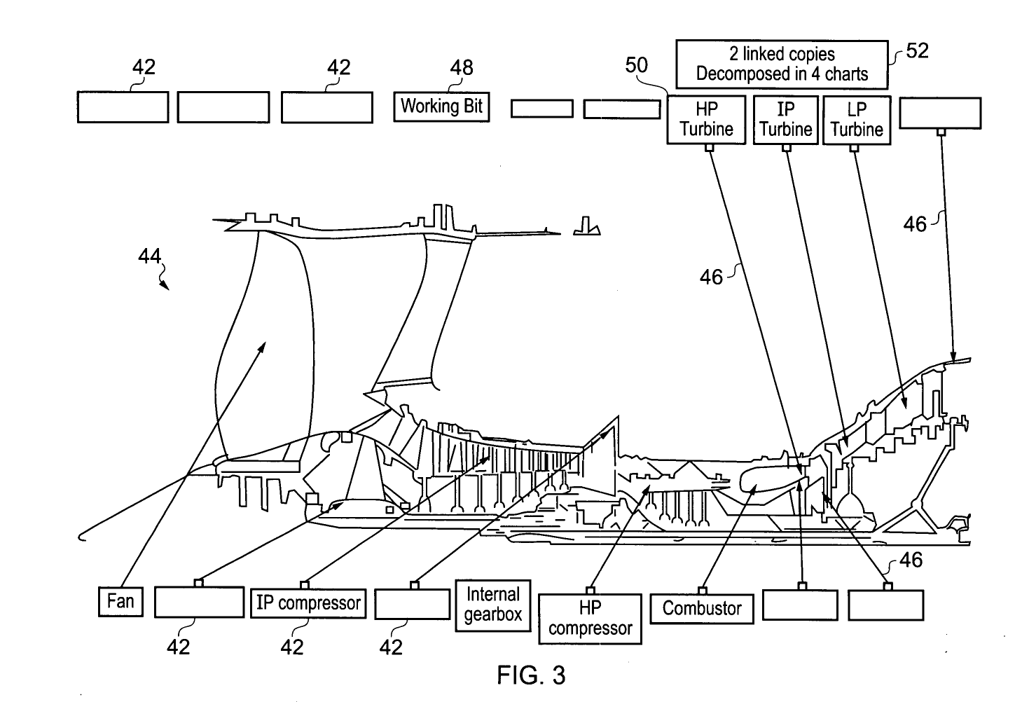

FIG. 3 shows a graphical representation of a product structure according to one embodiment of the present invention;

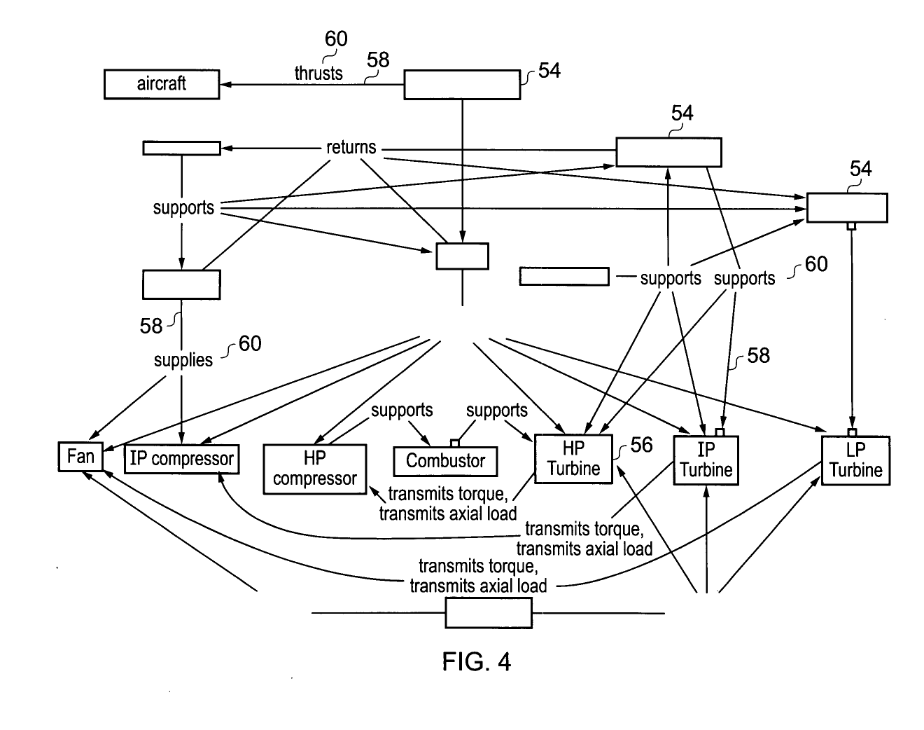

FIG. 4 shows a graphical representation of a first example of functional interactions between at least some of the physical entities identified in FIG. 2;

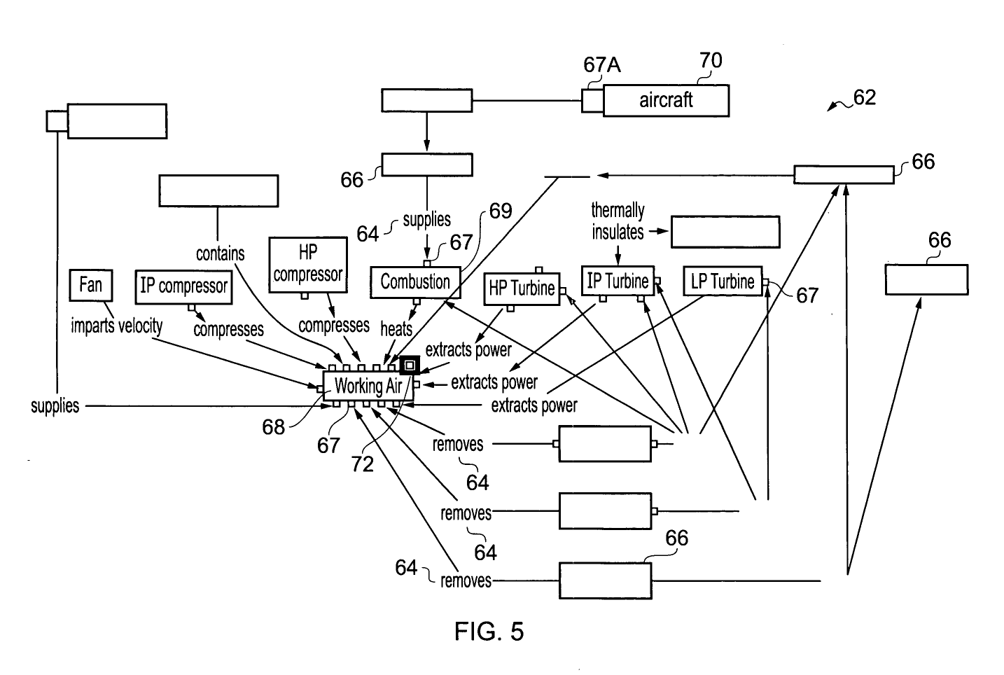

FIG. 5 shows a graphical representation of an further example of functional interactions between at least some of the physical components identified in FIG. 2;

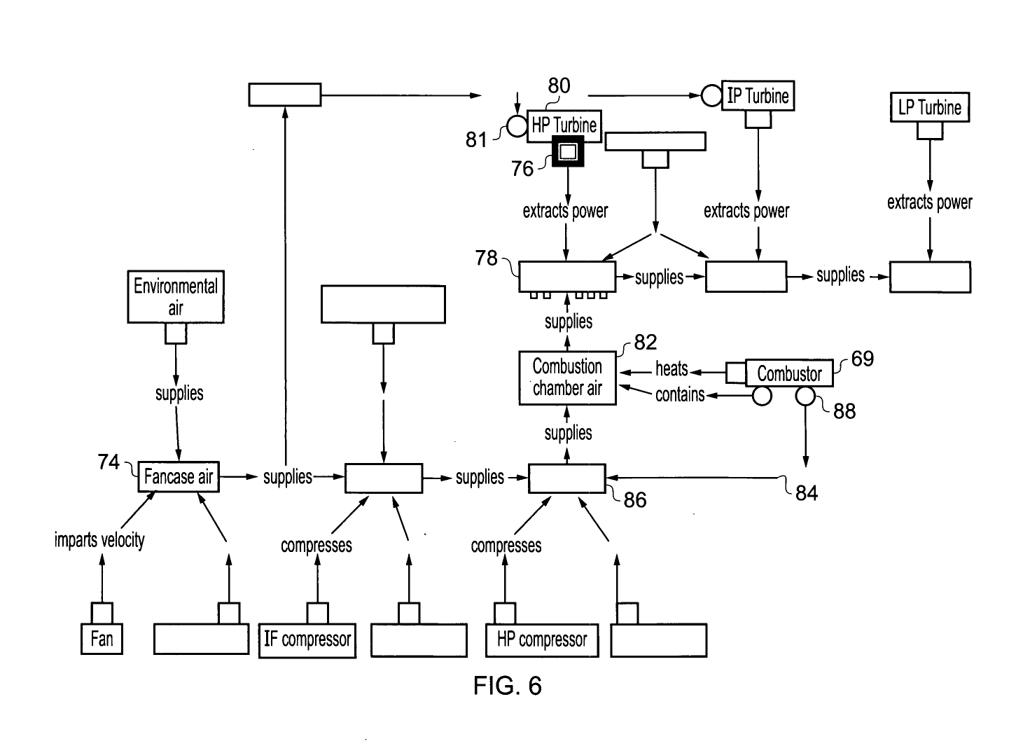

FIG. 6 shows a graphical representation of a decomposition of an entity represented in any one of FIGS. 2 to 4;

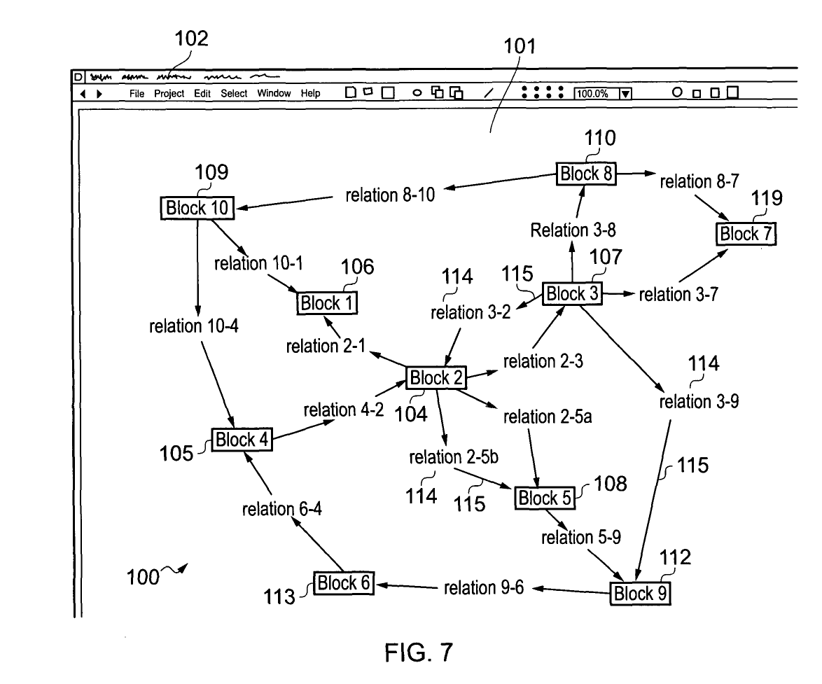

FIG. 7 shows a further graphical representation in accordance with a further embodiment of the invention, in which links between related graphical representations are managed in an alternative manner; and,

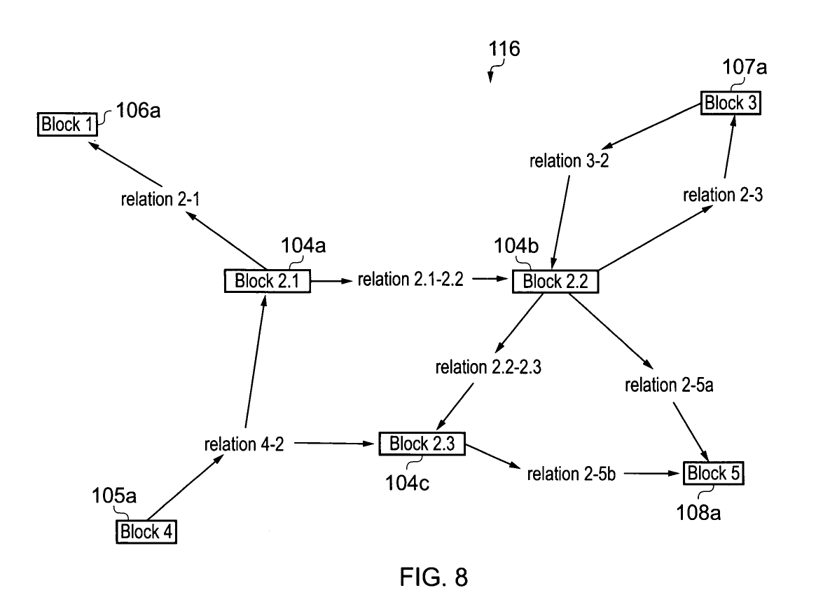

FIG. 8 shows a decomposition of FIG. 7.

The present invention is applicable to many technical or non-technical fields involving complex rational decision making activities by individuals and groups. The invention confers the ability to build, navigate and modify rationale information models, enabling them to be used to improve deliberation, communication and reuse. Whilst the present invention is particularly suited to the solving of complex design problems, it has been found that the same approach can be applied to problem solving in more general terms, including evaluation of scenarios or plans, investigative work and business decision evaluation and the like.

The tool and method disclosed in WO 2005/001721 allow design information—based primarily on an Issue-Based Information Structure (IBIS) design rationale structure—to be easily captured and communicated by design teams, without need for the installation of a dedicated database system. All captured information resides in graph-structured document files. A collection of such files capturing the state of a large project can be operated on as a single unified database, since bi-directional linking between any pair of nodes in different files is provided using tunnelling links.

However in WO2005/001721, the design rationale is stored as a structured graph which reflects the strategy used to approach the problem at hand. Thus, although the graphs are structured in that the nodes and links there-between must have predefined characteristics, the actual physical layout of that structure is user-defined. When complex and/or multiply compound problems are considered, the use of simple tunnel links between such graphical outputs has been found to leave room for improvement in allowing such a complex information structure to be clearly laid out and navigated easily.

The present invention serves to improve design deliberation and communication, by allowing creation of concept maps of complex systems, for example depicting beneficial and harmful behavioural relationships, with suitable links between map elements and design rationale issues, as well as with 2-D or 3-D assembly diagrams, and representations of the hierarchical product structure. The embodiments of the invention described below provide new tools to exploit Functional Analysis Diagrams (FADs) in a manner that allows for creation, capturing and analysis of design rationale.

The details of WO2005/001721 are incorporated herein by reference.

Turning now to FIG. 1, there is shown a schematic of an exemplary system within which the present invention may be deployed. The system 10 comprises one or more input/output means 12 which is operable under control of machine-readable instructions as will be described below. The machine readable instructions are typically stored as software on a memory of the input/output means 12. The input/output means 12 may be any one or any combination of features associated personal computers (PCs), laptops or dedicated CAed/CAD terminals or stations, or other portable or fixed processing means which allows for user interaction therewith. Such examples may include keyboards, display screens, touchscreens, a mouse, trackball, touchpad or other pointer control. The input/output means allows for data entry by a user; data transmission and receipt to/from a local or networked data store; processing of data in accordance with the present invention; and, output of information to a display screen for viewing by a user.

Input/output means 12 are connected to file system or file manager 14, which in turn provides access to a file server 15 and database 16. The file system 14 can be local or remote and may be connected to a wired or wireless network so as to allow communication therewith. The system is depicted as being configured as a network so that input/output terminals are connected, for example by way of a local area network (LAN) or a wide area network (WAN) to enable remotely spaced designers and engineers to collaborate on the same or different projects simultaneously. Links may include suitable encryption devices or software so as to ensure security of data as it passes, for example, over wireless networks or the Internet.

Other input ports may include, for example, wireless free connections 17, an Internet gateway 18, a real time information source 19, for example from an item under test (not shown); and/or a camera 20, showing a particular piece of video footage. Data, as will be described below, is collected and stored in accordance with the operations and commands in the computer program, as design decisions are made. Data is then stored, for example at database 16, so that it can be accessed subsequently either directly or else via the file manager 14. In this embodiment, the database 16 and server 15 can be considered to be a local database and local database server respectively.

However alternative arrangements are possible wherein databases or data storage devices are accessed over a network such as a LAN or WAN, such as, for example, the internet. In such circumstances, a server will typically control access to files and printers as shared resources on a computer network.

One or more printers 22 are connected to the processing means or file manager 14 in order to enable users to print hard copies of records as required. The printed output of one or more graphs produced in accordance an example of the present invention is comprehensive in its information content and provides hardcopy which closely matches information displayed on screen using the tool.

The invention may also be incorporated in an index-based knowledge system such as, for example, a database arrangement, for use with data items having one or more index terms associated therewith. In such a system a relationship storage means is operable to store relationship information relating to the index terms associated with the data items in the system. An identifier is operable to identify the or each index term contained in a user request for interrogating the index-based knowledge system and consulting means is operable to consult the relationship information to identify other index terms which are associated with data items with which the index term or terms of the request are associated. Using such tools, a user can submit a request and have returned to them information relating to the index terms or terms of the request.

Turning now to FIGS. 2 to 6, the functionality of one or more embodiments of the present invention will be described with reference to an example case involving the top down creation of an integrated product structure, geometry and FAD model for a gas turbine engine architecture. However the present invention is not limited to such applications and may be applied to design of mechanical or electrical machinery in general; architectural or civil engineering planning; as well as technical or non-technical processes, such as manufacturing processes, logistics and/or business process modelling. Indeed the present application can feasibly be applied to any entity having component parts and/or an operational environment which creates interaction therebetween and which is capable of graphical representation.

The terms ‘graph’, ‘chart’ or ‘graphics’ as used herein are intended to describe a visual output which is in the form of an image, diagram, schematic or any other form of pictorial representation and is not limited to the plotting of variables relative to axes. Such a graph is typically suitable for display within a graphical user interface of a user display or else within a printed document. Whilst such terminology provides an overview of the visual inputs or outputs catered for by the present invention, a preferred embodiment of the present invention makes use of a specific type of graph, namely a diagram as described in the examples below. The displays shown in FIGS. 2 to 6 may accordingly be considered to represent different types or formats of diagram.

FIG. 2 shows an example of a top level or macroscopic FAD 24 presented within the workspace (or display region) of a user interface 26. The user interface 26 may be common to all graphs of FIGS. 2-6 and provides user controls 28 to allow definition, creation, display, navigation and manipulation of FADs as described below.

FAD modelling within the tool is supported by definition of elements (blocks) and relationships that may exist there-between. Elements represent entities such as component parts, users or general resources within a product, system or process structure being modelled. The relations represent useful and harmful effects, behaviours or interactions between entities. Such principles can also be used for general purpose concept mapping within the framework of the present invention. In order to allow the flexibility of many-to-many relationships, the relations are defined as intermediate or relationship nodes linking the elements.

The FAD 24 is described as being a ‘top level’ since representation since it displays the most fundamental or primary entities which are required for modelling of the functional system at hand. In this example, the top level model 24 for a gas turbine engine is shown in FIG. 2. The gas turbine engine is represented by a single element or block 32, which is shaded so as to represent that it has an internal status. It is to be noted that the blocks or elements in this context are simple geometric shapes indicative of the existence of an entity within the system and are not representative of the real shape of geometry of the entity.

The engine is modelled as having behavioural or functional relationships with three other entities, namely an aircraft, environmental air and Engine Health Monitoring (EHM) data which are respectively represented as elements or blocks 34, 36 and 38. Those entities are modelled as being external to the entity under design and are represented as transparent or blank filled geometric shapes.

The primary, or most important, functional interactions between the entities are represented by way of a textual descriptor 39 accompanied by a directional line or connector 40 between the associated blocks 32-38. The descriptor serves as the intermediate relation node between related elements and the directions of the connectors 40 indicate the active and passive entities in the relationship. In this instance, the active entity (ie the entity providing the function) is at the root of the connector and the passive entity (ie the entity being acted upon) is at the tip of the connector.

The interactions between the entities are coded as being useful, harmful or neutral for the purpose of the design. Although not visible in FIG. 2, these codings are represented using links of different colours, such that useful relationships are green, harmful relationships are red and neutral relationships are black. In this example useful relations are that the environmental air 36 supplies the engine 32 which thrusts the aircraft 34 and provides health monitoring data 38. The other useful relations are that the aircraft 34 commands and supplies fuel to the engine 32. A harmful relation is that the engine 32 disturbs the environmental air 36. A neutral relation that the engine 32 accelerates the environmental air 36. The arrow links 40 connected to a relation element are automatically assigned the same colour as the element.

A navigational menu 30 is provided within the user interface, which has associated therewith a plurality of navigation buttons, to allow simple selection of related graphs for display. In this screenshot, it can be seen that the navigational menu 30 provides a list of the other graphs which are associated with the currently displayed graph. Such associated graphs may comprise transclusions or decompositions of the currently displayed graph or model. When an element is selected by a user, as shown by the thick border of the gas turbine engine element 32, the navigation menu 30 displays the graphs associated therewith for selection by a user. Shortcut keys also allow navigation to associated graphs for the selected element.

The related graphs are determined by links established between elements in different graphs. A bi-directional link is established between an element in one graph and an instance or occurrence of the same element in another graph. In addition to a basic bidirectional link which causes two graphs or elements therein to become associated, the tool recognises and supports two additional forms of bi-directional links, namely decomposition and transclusion links, which are used alongside the basic concept of tunnelling links. These links collectively provide an important enabler for effective large scale file-based hierarchical FAD modelling. Such links may be made between files or elements therein stored locally or else remotely (eg over a network via a server in a manner which is typically transparent to the user).

A transclusion in this context can be, defined as the inclusion of an element of a graphical representation within another graphical representation by reference thereto. Transclusions are typically at the same level of decomposition but need not be restricted as such. It has been considered to implement links using conventional hyperlinks. However such a hyperlink can only point to a single destination, and so a preferred embodiment has been devised to overcome the limitation that each region can only be transcluded once. Also conventional links are typically only unidirectional such that one end of the link knows nothing about the transcluded content.

Transclusion in the context of the present invention may be considered to entail the intentional appearance of a part of one document or diagram in another document/diagram such that the transcluded contents knows about its origin (ie a link from the transclusion to the original or master is maintained). A transclusion of any element in a graph may be provided by hyperlinking to and capturing a bitmap image in a file element. The region need only be hyperlinked to a single file element, but that element can then in turn be transcluded as many times as necessary.

Information about transclusions is kept with the master node. In addition, each transclusion keeps information about its master; as an attribute of an element (node). The transcluded element may maintain a list of its transclusions. Alternatively, a lightweight local database can be employed for this purpose. This allows attributes of the transclusion—such as the content and/or the appearance—to follow any changes of these attributes of the master. Thus updates for the transclusions can be initiated by a user at any time and the updates will then be carried through transclusions as necessary.

Where a link from the transclusion to the master is supported within the software and the transclusions can be identified visually, then the user can start either at the master or at the transclusion and navigate between the master and different transclusions in a chain. A user is thus able to navigate the list of transclusions in a round-robin fashion. To this end a circular buffer or a doubly linked circular queue can be defined that contains both the master and the transclusions. Whilst this represents one implementation of the invention, it is to be noted that other techniques for managing an ordered list or queue are possible. The rules for adding to and deleting from the buffer and navigating the buffer can then be implemented according to the technique adopted.

Decompositions refer to graphical representations of constituent elements which make up an element at a higher level. Thus decomposition exist at a lower level than the parent element which is the subject of the decomposition. A decomposition denotes a situation where a whole graph defines the contents of a single node in another graph. An element may therefore be defined as being decomposable if a lower level graph is dedicated to that element. Accordingly bi-directional links can be established between a block or task located in one chart and another whole chart decomposing it. In the preferred embodiment, a decomposable element is allowed to be decomposed in more than one chart, but a chart is only allowed to decompose a single element.

The flexibility and robustness of all three forms of bi-directional links (tunnelling, decomposition and transclusion) is enhanced by the application of Open Software Foundation standard Universally Unique Identifiers (UUIDs) for all DRed chart files and linked external files such as MS Office documents. The implementation of such attributes has been found to be beneficial when compared to tunnelling links based solely on recording relative pathnames between files in a design folder since it allows for arbitrary file renaming and rearrangement is made possible without affecting navigation between graphs.

In the example of FIG. 2, three options for navigation are displayed. The first two options relate to further FADs, which are represented by FIGS. 4 and 5, whist the third option relates to an assembly or geometric display of the engine as shown in FIG. 3. Selecting the third option results in a new window opening having the structural display of FIG. 3 therein.

Turning to FIG. 3, there is shown a general assembly drawing of the whole gas turbine engine. A bi-directional decomposition link is provided between the graphical representations of FIGS. 2 and 3 so as to allow navigation there-between. Thus, upon selecting the requisite navigation option, a user can simply switch from one graph to a transclusion or decomposition thereof. In this embodiment a bitmap image is displayed in a file element and, although not indicated in FIG. 3, the image is presented with accompanying textual details to indicate that the graph is representative of a decomposition of the relevant element 32 in FIG. 2. This textual information may be displayed as a title, such as for example, ‘Decomposes XXX gas turbine engine” in “XXX Top Level.dre”. The latter portion of the title displays the other end of the bi-directional decomposition link.

In FIG. 3, a plurality of elements 42 are displayed in conjunction with the structural representation 44 of the gas turbine engine. The combination of elements 42 and image 44 provide a decomposition of the gas turbine engine element 32 of FIG. 2. The elements 42 define the next level of the hierarchical decomposition of the engine and, where the sub-assembly defined by an element 42 is identifiable in the assembly image 44, a connector in the form of a directional line 46 pointing from the block is anchored to the location in the drawing.

It will be appreciated that the elements 42 at this level of decomposition would typically be shaded to represent internal entities such as components, sub-assemblies or a functional medium. However certain elements 42 are left blank or unpopulated for simplicity. Element 48 represents an important entity not represented in the bill of materials product breakdown, entitled ‘Working air’. As shown in FIG. 3, multiple elements 42 can be included in the graph which are not labelled and/or do not appear in the structural representation 44.

The structural representation 44 of the gas turbine engine is in this example a half longitudinal section which is standard in the industry. However alternative 2D or 3D views used in conventional CAD practice to show structural features may be used dependent on the information and features to be communicated. The detail and number of components or sub-assemblies listed is subjective dependent on the number of levels of decomposition created for the system under design and also the level of detail considered relevant at each level. For example, at this level, the major components are listed such as the HP, IP and LP compressors, rather than the individual compressor stages or rotor and stator components thereof. However a decomposition of the IP compressor for example would likely include such details and a further decomposition thereof may include, for example, structural and internal details of rotor blades or stator vanes.

Whilst the representation 44 is referred to as being structural in nature, it does not in this example relate to the structural interaction of the individual components. Instead the representation 44 shows the physical layout including special features such as the geometry, spacings, orientation and/or juxtaposition of constituent entities. Whilst the present example shows use in relation to a physical product or system, it will be appreciated that such principles can equally be applied to a process or other functional system. In such examples, the physical entities which are involved in the process can be mapped in a similar manner. Corresponding methodology may also be applied to the mapping of functional entities or stages within a method or process definition. For example functional entities may be mapped in a temporal rather than physical space such that methodology can be potentially recorded in a similar manner without the need for reference to physical equipment or resources. In other applications, it may not be relevant to use CAD outputs for the graphical representations but instead other types of image such as for example, schematics of buildings or other structures, plans, drawings, photographs or the like. Accordingly the term ‘map’ is used to refer to such a chart in which the relative spacial or temporal orientations of the elements are shown rather than the functional interaction thereof.

In FIG. 3, the element 50, entitled ‘HP turbine’, is selected in the view shown. The presence of the mouse pointer in the vicinity of the element 50 causes a user-information box 52 being automatically displayed to indicate the number and type of linked graphs in which the element 52 occurs. In this example the element 52 ‘HP turbine’ is linked to two charts which represent transclusions and four charts which represent decompositions of the current graph element. With this block selected, clicking either of the transclusion navigation buttons (or associated shortcut keys) will enable a traversal of this block and its two transclusions in other charts, going either backwards or forwards respectively through the list. Similarly navigation buttons or associated shortcut keys can be used to select from or cycle through a list of the linked decompositions.

Going forward one step in the transclusion list for element 52 opens a window comprising the chart shown in FIG. 4. This is a mechanical FAD of the whole engine, which provides an alternative type of decomposition of block 32 in FIG. 2 to that shown in FIG. 3. Both decompositions may be created in any one project as useful alternative definitions of the same entities. All the elements 54 shown in FIG. 3 are also represented as elements 42 in the map of FIG. 3. The transcluded image of “HP turbine” element 52 of FIG. 3 is shown as element 56 in FIG. 4, which has been selected by the user. The transcluded nature of the element 56 is denoted by a visual attribute such as a colour or marker in order to allow it to be distinguished from other non-transcluded elements 54 in the diagram.

The FAD of FIG. 4 thus represents a lower level FAD than that of FIG. 2. However the same rules and notation apply in defining the functional relationships of the elements making up the lower level FAD as are described in relation to the top level FAD of FIG. 2. Thus directional connectors (lines) 58 and associated functional descriptors 60 are used to define the functional relationships or inter-relationships that exist between the elements constituting the gas turbine engine at this level of decomposition.

If the user navigates to the second transclusion of HP turbine element 50 or 56, this results an alternative decomposition of the gas turbine engine as shown in FIG. 5. The graphs of FIGS. 4 and 5 thus represent different functional definitions (namely a thermofluid and a mechanical definition) of a particular entity, in this example, the gas turbine engine, which exist at the same hierarchical level of decomposition. The differing nature of the definitions allows for alternative or complimentary definitions to be captured. The graph 62 of FIG. 5 represents a thermofluid FAD. Thus the functional interactions 64 of the elements 66 in FIG. 5 are modelled in terms of their relevance to the thermal energy in the system. In the case of the gas turbine engine, this can be described in terms of each element's interaction with a working thermofluid in the system, such as air.

In FIG. 5, it can be seen that a number of elements 66 have indicators 67 thereon in the form of geometric formations protruding from the border of the element 66. In this embodiment, the geometric formations take the form of rectangles having dimensions smaller than that of the element to which they are appended. A number of such indicators 67 can be seen appended to the element 68 which represents the physical entity of the working air within the gas turbine engine. Indicators 67 may be provided on elements for which a link to another graph, such as a transclusion or decomposition, exists within the design rationale. A functional relationship 64 connector may terminate at the border of an element 68 or else at an indicator 67 appended to an element. The former situation signifies that the designated functional relationship originates from, or applies to, the element as a whole, whereas the latter situation signifies that the functional relationship originates from, or applies to, a specific location, feature or sub-element within that element. Thus the indicators 67 demonstrate visually that there is another level of detail to be assessed in accurately reviewing the implications of a functional relationship which starts or terminates at an indicator. Accordingly, the function should be more precisely joined to a sub-element within a decomposition for the element in question.

The indicators 67 may be considered to indicate where a functional relationship exists between elements in two linked charts over a level of decomposition hierarchy. The size of the indicators 67 between linked elements is used to indicate the level of decomposition. For example, the indicator 67A appended to the aircraft element 70 in FIG. 5 is substantially larger than the indicators 67 used on elements at a level below (ie within the gas turbine engine decomposition). In this embodiment, an indicator at a higher level in the decomposition is reduced in size by a factor of about three. This enables it to be aligned unobtrusively on the edge of the block decomposed in the chart of the tunnel destination. Thus the tunnel-end appears as a port into the decomposed block, linking to a particular sub-block in the decomposition.

An example of this functionality is given in the highlighted indicator 72 appended to the “Working air” element 68 in FIG. 5. That indicator links to the useful relation “extracts power” which is performed by “HP turbine”. The “Working air” block 68 is decomposed in the chart in FIG. 6, which shows that “Working air” consists of various parts, such as “Fancase air” (element 74), along with a number of other elements. While browsing the chart in FIG. 5, a user might be interested in knowing what part of the “Working air” the “HP turbine” extracts power from. The answer is obtained by double clicking the highlighted indicator 72, causing the tunnel link to be traversed into the decomposition of “Working Air” in FIG. 6. The termination of the tunnel link is now highlighted at 76 as shown in FIG. 6, this time represented by an indicator of greater size. This links to a transclusion of the “extract power” relation from the level above, transcluded so that the relation is visible on both decomposition levels. This then links to the part of the “Working air” from which power in extracted, that can be seen in this case is element 78.

However there is still a need to show in the chart in FIG. 6 what product structure element on the level above extracts power from the element 78. This is done by aligning with the tunnel link end a block having external status (signified by white background fill), showing that the destination is “HP turbine”. The software according to the present invention is able to create these appropriate external blocks to document decomposition tunnel links automatically.

The hierarchical FAD model is also able to cater for any relationships which may exist directly between any pair of blocks, at any levels in the product breakdown. Take for example the combustor 69 and working air 68 blocks in the whole engine thermofluid FAD of FIG. 5. The only thermofluid functional relationship between these elements at the whole engine level is that the combustor heats the working air. However, going down into the thermofluid decomposition of working air in FIG. 6, it can be seen additionally that some part of the combustor 69 also contains the combustion chamber air 82. Some part of the combustor may also perform another function on another element of the working air as indicated by relationship 84 and associated element 86. These additional relationships are carried by tunnels cross-linking the decomposition hierarchy. For this purpose an alternative geometric shape of indicator 88 is used to denote the tunnel-ends adjacent to the combustor external block. Those indicators in this embodiment are circular in shape rather than rectangular. If an engineer wanted to find what part of the combustor was performing each function, double clicking either tunnel end 88 would open the thermofluid FAD decomposition of combustor element 69.

It will be appreciated to those skilled in the art that the transclusion approach of graph-structured documents described above may be described as comprising a master element and linked copies. However master-less transclusion could be implemented as an alternative approach within the scope of the present invention. In such an embodiment every element in a list of transclusions maintains links to all the others. Thus if any element in the list is edited, and all other linked transclusions are automatically updated to keep them all identical. Whilst this does represent a possible alternative approach, it is felt that the master element approach is advantageous in that it does not require all files containing a transclusion of that element to be opened simultaneously for editing, whilst remaining locked against editing by other users.

An alternative embodiment of the present invention, which provides for an alternative method of linking between graphical representations, and associated method of indicating linking relationships, to that described in relation to FIGS. 5 and 6 will now be described in relation to FIGS. 7 and 8.

FIG. 7 shows a relatively higher FAD in the hierarchical model structure described above and FIG. 8 shows a relatively lower FAD, which represents an at least partial decomposition of the FAD of FIG. 7. FIG. 7 may be considered a further example of the graphical representation of the type described in relation to FIGS. 2 to 4 above. Accordingly any of the features described in relation to FIGS. 2 to 4 may be applied to FIG. 7. Accordingly the embodiments of FIGS. 7 and 8 could accommodate functional or structural diagrams or any combination of the two.

In FIG. 7, the FAD 100 is displayed within a display region 101 of user interface 102 and comprises a plurality of elements 104 to 113 denoting entities within the system and indicators of functional interactions existing there-between. The functional interactions are represented by way of a textual descriptor 114 accompanied by a directional line or connector 115 in the manner described above. However it can be seen that the linking indicators 67, 76, 81 and 88 described above in relation to FIGS. 5 and 6 are omitted from FIGS. 7 and 8 in favour of an alternative method of linking between related graph-structured document files.

FIG. 8 represents a decomposition 116 of FAD 100 of FIG. 7 in which element 104 has been decomposed into elements 104a, 104b and 104c, which may be considered to be sub-elements of element 104. The elements 105 to 108 from FIG. 7 which interact directly with element 104 are indicated in FIG. 8 by transcluded elements 105a to 108a and linked with the relevant sub-element 104a, 104b or 104c in order to provide further detail of the interaction of those elements with element 104.

In contrast to the linking method of FIGS. 5 and 6, the elements 105a to 108a in the lower level chart 116 are transclusions of the corresponding elements 105 to 108 in upper level chart 100. The use of trancluded elements in this manner simplifies the layout of the graphical representation whilst allowing navigation between different layers by selection of the required transcluded element itself, rather than a linking indicator appended thereto. In this manner, a user can select the relevant element to navigate to any other instances of the transcluded block, whether it is an upper or lower level of the hierarchy. In the event that multiple navigation options are available for a single element, when a user selects that element, a list or menu of available navigation options may appear on screen. Alternatively a user may navigate through the options by clicking through the available graphical representations in which that element appears until the required graphical representation is displayed.

As shown in the lower level FAD 116 of FIG. 8, the translusions (linked copies) 105a to 108a of elements 105 to 108 are coloured white. In contrast, the decomposed elements 104a to 104c are shaded. Thus the white filled nature of elements 105a to 108a in the lower level FAD signify that they are external to the FAD 116. In this manner, various shading or colouring techniques for the elements can be used to indicated whether the elements are at the same or different levels of decomposition within a single graphical representation. That is to say, the colour or shading schemes can be used to indicate whether the elements represent a decomposition or transclusion of elements in the level above. Different shading schemes may make use of different grades of shading or different hatching techniques or styles.

In one example, a particular colour or shading may be assigned to each level of decomposition within the hierarchical model. Each element may be assigned the colour or shading prescribed to the highest level on which that element features. That is to say that each transclusion of an element can retain the colour or shading applied to the original element. The user interface 102 may provide an indicator of the current level of decomposition by displaying the current level colour or shading so as to make clear which elements are of the current level and which originate at an alternative level of the hierarchy. This may be especially useful for large and/or complicated models which have multiple levels of decomposition.

According to a further development of the present invention, a relation node/element (or a transclusion of such a relation node) can sense if it is linked in a FAD to a block transclusion displayed as having external status. For that relation, a default action upon a user input—such as a “double-click” or “select and hit enter” input—can be modified to simplify navigation through linked graphs as described below.

In such circumstances the relationship's default double-click response becomes a search of its transclusion list to display a transclusion linked to an internal version of the external element which is associated with the selected relationship. The relation (or transclusion of one) found by this process is then selected and the mouse pointer moved over it, in a manner similar to that used when navigating a tunnel link.

An immediate second double click allows a user to return to the starting point. This is because the originally associated internal element will now have an external status, so performing the search step described above will return the relationship originally chosen by a user. That relationship will thus be found, displayed and selected. This development allows simple back-and-forth exploration of both ends of a relation triple without needing to take potentially multiple steps up and down the decomposition hierarchy.

Wherever practicable, any of the optional or alternative features of the embodiments described above may be combined or interchanged in order to generate further embodiments.

The present invention is considered to be particularly advantageous when applied to design of complex products, systems or processes in which successive generations are consciously adapted from one or more predecessors, for example in response to changes in specification and developments in technology. Hence it is a highly beneficial design aid to both individual and team design thinking to have a hierarchical model of the previous generation product, system or process, which is structured according to the familiar architecture. This allows the browsing not just of part and assembly geometry, but also useful and harmful behavioural relations and linked rationale justifying geometry and material choice decisions within a single, easily-navigated framework.

The graphical representations created using the present invention may be stored and shared in the same way as other files used in the design process, for example using email attachments, personal and shared folders, web servers and PLM systems. The collection of graph-structured document files, linked by three types of bi-directional link, can be computationally manipulated to extract information in various forms suitable for further tasks in the design process, such as requirement lists, function lists, functional analysis matrices, and Quality Function Deployment matrices.

1. An analysis information capture tool comprising:
a storage means for storing the analysis information generated or acquired during progress of an analysis project, wherein the analysis information comprises a plurality of graphical representations, each graphical representation denoting a plurality of entities under analysis, said plurality of graphical representations comprising at least one representation of a first kind and at least one representation of a second kind;
input means for allowing a user to generate each graphical representation using a first or second predetermined structure according to its kind, said graphical representations being arranged for storage as a plurality of graphical representation files in the storage means; and
a presentation means for presenting the analysis information comprising the at least one graphical representation,
wherein a bi-directional link is created between different graphical representations denoting a common entity under analysis such that the bi-directional link allows navigation between the linked graphical representations by traversing the bi-directional link in either direction.

2. A tool according to claim 1, wherein the first structure for the first kind of graphical representation comprises a plurality of elements, each element being representative of an entity which impacts on said analysis, and a plurality of connectors therebetween, the connectors being representative of a functional relationship existing between two or more entities.

3. A tool according to claim 2, wherein each connector comprises an accompanying descriptor to describe the relationship between two or more elements.

4. A tool according to claim 3, wherein the descriptor is modelled as an intermediate node between two or more elements.

5. A tool according to claim 1, wherein the second structure for the second kind of graphical representation comprises an image showing the relative ordering, structure or orientation of a plurality of entities under analysis.

6. A tool according to claim 5, further comprising elements for annotation of the entities denoted therein.

7. A tool according to claim 5, wherein the second kind of graphical representation is indicative of the actual or proposed physical layout of the plurality of entities under analysis.

8. A tool according to claim 1, comprising an additional kind of graphical representation having a further predetermined structure comprising an array of elements, each element representing a description of an issue under analysis, wherein dependency between said issues is denoted by connectors joining said elements.

9. A tool according to claim 8, wherein status identifiers accompany each element to denote the status of resolve for that issue.

10. A tool according to claim 1, wherein each graphical representation is stored as a separate file.

11. A tool according to claim 1, wherein elements within a graphical representation are used to denote entities or issues under analysis and a bi-directional link is formed between each occurrences of an element denoted in a plurality of graphical representations.

12. A tool according to claim 1, comprising two or more types of bi-directional links to distinguish different types of relationship between linked graphical representations.

13. A tool according to claim 12, wherein the types of bidirectional link comprise any combination of a tunnelling link, a transclusion link and/or a decomposition link.

14. A tool according to claim 12, wherein visual indicia of differing shape, size or colour within the graphical representation are used to denote different types of link relationship between elements in linked graphical representations.

15. A tool according to any claim 1, in which the first kind of graphical representation comprises a functional analysis diagram and the second kind of graphical representation comprises a physical special representation of a plurality of entities under analysis.

16. A tool according to claim 1, in which the bi-directional link is formed between a first element in a first graphical representation and a decomposition of said element in a second graphical representation, said decomposition comprising a plurality of elements at a lower level of decomposition hierarchy than the first element.

17. An analysis information capture method comprising:
generating analysis information comprises a plurality of graphical representations denoting a plurality of entities under analysis, said plurality of graphical representations comprising at least one representation of a first kind and at least one representation of a second kind, wherein the first kind of representation is generated according to a first predetermined structure and the second kind of representation is generated according to a second predetermined structure which differs from said first structure;
determining where a common entity is denoted in two or more graphical representations and creating a bi-directional link between said graphical representations denoting a common entity under analysis;
storing said plurality of graphical representations as a plurality of graphical representation files and associated bi-directional links in a storage means so as to allow subsequent retrieval and presentation of said graphical representations, wherein the bi-directional links allows navigation between the linked graphical representations by traversing the bi-directional link in either direction.

18. A data carrier comprising machine readable instructions for control of one or more processors to capture analysis information acquired during progress of an analysis project by:
providing a first framework for creation of a first kind of graphical representation by a user;
providing a second framework for creation of a second kind of graphical representation by a user; wherein each of said frameworks comprises elements denoting physical entities or issues under analysis;
facilitating bi-directional linking between two or more graphical representations denoting a common element;
storing said plurality of graphical representations as a plurality of graphical representation files and associated bi-directional links in a storage means in such a manner as to allow subsequent retrieving and presenting of said graphical representations and navigation between the linked graphical representations by traversing the bi-directional link in either direction.

19. An analysis information capture tool comprising:
a storage means for storing the analysis information generated or acquired during progress of an analysis project, wherein the analysis information comprises a plurality of graphical representations arranged for storage as a plurality of graphical representation files;
an input means for allowing a user to generate each graphical representation according to a predetermined framework for storage in the storage means, the framework comprising a plurality of elements, each element being representative of an entity which impacts on said analysis, and a plurality of connectors therebetween, the connectors being representative of a functional relationship existing between two or more entities; and
a presentation means for presenting the analysis information comprising the at least one graphical representation, wherein a bi-directional link is created between instances of the same element denoted in a plurality of graphical representations such that the bi-directional link allows navigation between the associated graphical representation files containing said element by traversing the bi-directional link in either direction.
